(19) United States
(12) Patent Application Publication
(10) Pub. No.: US 2010/0061792 A1
(43) Pub. Date: Mar. 11, 2010

(54) WRITING IMPLEMENT COMPRISING ELASTIC LAMELLAE TO PREVENT AGAINST TWISTING

(75) Inventor: Peter Koreska, Wien (AT)

Correspondence Address: PILLSBURY WINTHROP SHAW PITTMAN, LLP, P.O. BOX 10500, MCLEAN, VA, 22102, US

(73) Assignee: KORES HOLDING ZUG AG, Zug (CH)

(21) Appl. No.: 12/516,724

(22) PCT Filed: Nov. 29, 2007
(86) PCT No.: PCT/AT2007/000537

§ 371 Date: May 28, 2009

(30) Foreign Application Priority Data
Nov. 30, 2006 (AT) GM 841/2006

(51) Int. Cl. B43K 21/08

(52) U.S. Cl. 401/75

(57) ABSTRACT

A writing implement with a sleeve, which has an open front end and in which a lead is displaceably retained by means of a spindle-drive mechanism having a rotary element, wherein the lead, which cooperates with the rotary element, itself forms the spindle and is secured in the sleeve against rotation. Inside of the sleeve, elastic lamellae are provided which engage recesses located on the outside of the lead.

The invention relates to a writing implement with a sleeve, which has an open front end and in which a lead is displaceably retained by means of a spindle-drive mechanism having a rotary element, wherein the lead, which cooperates with the rotary element, itself forms the spindle and is held in the sleeve against rotation.

A number of writing implements is known in which the lead is advanced by means of a rotary mechanism, which transforms a rotary movement into a longitudinal movement.

DE 32 10 681 A1 describes a writing implement with a rotatable front and rear body part, and a lead. The rear body part is rotatably connected to the front body part via a snap-fit connection (annular groove and annular web). The lead has a screw thread and is threadedly engaged with the front body part. At its rear end, the lead is held against rotation by means of projecting tongues which are insertable into key slots in the head of the rear body part. Since the lead is retained at its end only, a co-rotating retention is possible to a limited extent only. Therefore, and also on account of the tongues, there always remains a short piece of unused lead in the front body part of the writing implement. It is difficult to remove the remaining lead portion for exchanging the same since the lead portion can no longer be moved out of the writing implement because of the lack of a thread in its end portion and because of the projecting tongues.

From DE 742 421 C, a propelling pencil is known which has a spindle-drive-type feed mechanism, in which a lead-feed pin engages the thread of a threaded spindle by means of a lug so as to advance the lead during rotation. The structure of this propelling pencil is relatively complex since it requires several constructional parts to ensure a reliable feed mechanism. The lug can break off easily, and advancing the lead will thus no longer be possible.

CH167 532 A likewise describes a propelling pencil with a threaded spindle that cooperates with a spindle nut for advancing a lead. Here, the spindle nut is fixedly arranged in a hollow grip sleeve at some distance in front of the center of the same. The threaded spindle extends through the spindle nut and is axially moved forwards upon rotation of a rear rotary knob. Here, the front end of the spindle pushes the lead forwards. Since the lead is present in front of the threaded spindle it can only be short, provided that a usual length of the propelling pencil is used, so that the lead has to be exchanged frequently.

From GB 142 270 A, a writing implement is known in which also a relatively short lead is advanced by means of a spindle-drive, and in which the lead is retained only by a narrowed diameter in the front region of the writing implement.

A similar propelling pencil with spindle drive is disclosed in the GB 1914-24035 A, wherein a catch, which is arranged in the rear part of the pin's sleeve, has a head for moving the lead provided in the front part of the sleeve out of the propelling pencil.

From U.S. Pat. No. 1,853,561 A, a pen with a feed portion is likewise known in which the lead is received in the lead holder which, via a guide slot, cooperates with the feed portion for moving the lead outwards.

To prevent a lead from unintentionally sliding back and rotating in a propelling pencil, it is known from CH 219 675 A to provide for a locking clamp which has longitudinal webs engaging the lead for retaining the same.

All these known writing implements have in common that they include relatively complex constructions for advancing the lead, such as several intermeshing sleeves and/or sleeve parts, which is not only costly and unprofitable with regard to production and assembly but also leads to faults and/or failures during use. Moreover, handling is quite cumbersome when, in case of propelling pins, the rotary element is provided at the rear end thereof. Furthermore, the lead is in most cases short so that a frequent exchange of the lead is necessary. As regards protection against rotation, the solution is not satisfying either. In most cases, such a protection against rotation is provided only in certain parts, e.g. at the end and/or the head of the propelling pencil, in the form of tongues, which is why the lead can easily detach and might rotate.

It is now the object of the invention to provide a writing implement of the initially-defined type which provides for a safe protection of the lead against rotation, is of a simple construction, is cost-effective in production, and is reliable during use. Moreover, the writing implement shall also be suitable for long leads, wherein removal of the lead or the remaining piece of the lead shall be facilitated.

This object is achieved by a writing implement which is characterized in that elastic lamellae are provided inside of the sleeve which engage recesses located on the outside of the lead. This engagement allows for the elastic lamellae to hold the lead safely against unintentional rotation during its advancement caused by the spindle-drive mechanism, and for a precise guide of the lead inside of the sleeve. This enables prevention of a lateral and unintentional movement of the lead. Due to their elasticity, the lamellae can engage the recesses of the lead in a simple manner and without high resistance during assembly. Furthermore, the elastic lamellae can hold the lead resiliently, and in case of an impact of the writing implement on a hard ground, they can have a cushioning effect on the lead.

The elasticity of the lamellae may result, e.g., from selection of appropriate materials and/or from the fact that the lamellae have an appropriate wall thickness. For example, the lamellae may have a wall thickness of some tenths of a mm, e.g. from about 0.3 mm to about 0.6 mm.

The writing implement has the additional advantage of being comprised of substantially only two structural components. Due to the simple spindle-drive mechanism in which the lead itself forms the spindle a highly safe and reliable rotary mechanism is obtained which does not require for any additional sleeve elements, which is why the writing implement is simple and cost-effective in production. Moreover, the length of the sleeve for the lead can be utilized almost completely, which is why long leads can be used and an early refilling of a lead is prevented.

The thread provided for forming the lead as a spindle preferably extends across the entire length of the lead. By screwing the lead completely out of the rotary element in a simple manner the lead can be removed from the writing implement for exchanging the same.

A particularly efficient effect of the lamellae as regards protection against rotation, guide and resilience is the case if the lamellae extend across the length of the sleeve. For holding the lead, it is also favorable if at least three, preferably four, lamellae are provided at same angular distances.

As to simple construction, and thus also simple production, it is advantageous if the lamellae are integral with the sleeve.

For example, if different materials are to be used, the lamellae may also be retained in the sleeve in a longitudinal groove at the inner side of the sleeve. Thanks to this simple structure of the writing implement, the lamellae can also be exchanged, if necessary. Here, it is also possible for the sleeve to be produced from metal, if desired, and for the lamellae to be produced from synthetic material.

Furthermore, for cooperation of lamellae and lead, in particular as regards protection against rotation as well as lead guide, it is advantageous if the recesses in the lead are formed by longitudinal slots saw-tooth-shaped in cross-section.

For easy handling of the writing implement, in particular for a “one-hand” operation, it is beneficial if the rotary element is arranged at the front end of the sleeve.

For a particular simple and cost-effective structure of the spindle-drive, it is advantageous if the rotary element itself forms the spindle nut.

Alternatively, an outer rotary element may be provided which is connected to an inner spindle nut in a co-rotating manner. Here, a “one-hand” operation is possible as well since the rotary element is likewise provided in the front region of the writing implement.

For a simple co-rotating coupling of rotary element and spindle nut, it is advantageous if the co-rotating connection is formed by an eccentric pin which is retained in the rotary element and engages the spindle nut. It goes without saying that a different, in particular positive-fit, rotation protection between rotary element and spindle nut is also conceivable.

It is likewise conceivable for the spindle nut to cut a thread into the lead during operation. Here, it is advantageous if the internal thread of the rotary element and/or the spindle nut is (are) designed as a thread-cutting device for the lead. The rotary element and/or the spindle nut may be produced, e.g. from metal, so as to provide for a higher efficacy as a thread-cutting device. In this case, any conventional leads can be used with the writing implement, wherein the thread can be cut into the lead in a simple manner upon rotation of the rotary element. Yet, to protect the lead during operation, it is beneficial if the lead has a preformed thread. Here, it is likewise beneficial that the spindle nut and/or the rotary element is (are) made of the same material as the sleeve, i.e. synthetic material.

According to a simple design of the writing implement, the rotary element may be detachably connected to the sleeve by means of a positive-fit connection. The positive-fit connection may be designed in a manner known per se, e.g., as a peripheral boss at the rotary element, or at the sleeve, which can snap in a recess or groove of the sleeve or the rotary element. The detachable connection of the rotary element and the sleeve, and the arrangement of the rotary element at the front end of the sleeve, is also advantageous since the lead can be exchanged in a particularly simple manner when the rotary element has been removed.

A simple assembly is also achieved if the rotary element is retained rotatably at the sleeve by means of an annular bracket. This is particularly beneficial if an outer rotary element is provided which is coupled to a separate inner spindle nut in a co-rotating manner.

It is basically also conceivable for the writing implement to be provided not only with a conventional pencil lead but also with a color lead. To this end, at least one inspection window may be provided at the sleeve so that the consumer and user can directly see the respective color of the lead in the writing implement. Of course, it is likewise possible for the sleeve itself to be designed according to the lead color. An inspection window is also advantageous since the user can then also detect if a lead has to be exchanged soon. To this end, it is beneficial if the inspection window is provided from the front region to the center region of the writing implement and/or the sleeve.

The writing implement is suited as a disposable product (disposable pencil) with already inserted lead or as a housing with refill option. In particular for the last purpose of use, an end cap may be provided which is detachably connected to the rear end of the sleeve. Thus, a lead can simply be inserted into the writing implement from the rear end. Likewise, it is conceivable to provide for a rubber eraser or the like at the rear end of the sleeve, said rubber eraser being removable for exchanging the same (and the lead). A “consumed” lead can be removed from the front through the open front end of the sleeve, e.g. simply by screwing out the lead manually, what is possible in an easy manner since the lamellae do not engage the lead any longer.

Natural or synthetic materials, or mixtures thereof, can be used as materials for producing the inventive writing implement and/or the sleeve and the rotary element, wherein production of the sleeve and/or the rotary element from nylon (polyamide 6.6) has proven to be an optimal compromise as regards strength, elasticity of the lamellae, grip of the exterior, etc.

In the following, the invention will be explained in more detail by way of the preferred exemplary embodiments illustrated in the drawing, yet without being restricted thereto. Therein:

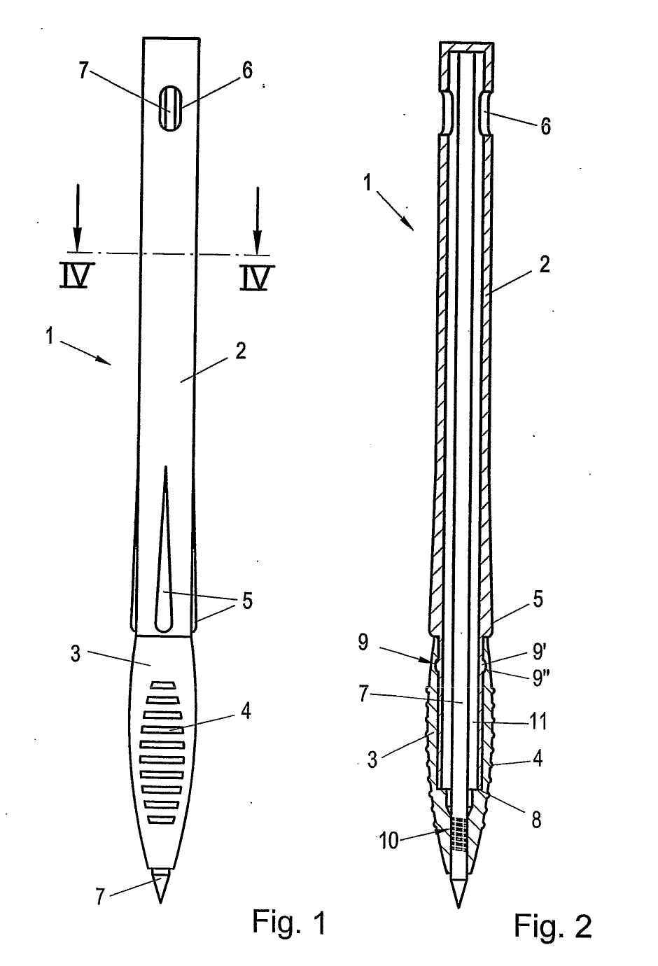

FIG. 1 shows a side view of the inventive writing implement;

FIG. 2 shows an axial section of the writing implement according to FIG. 1;

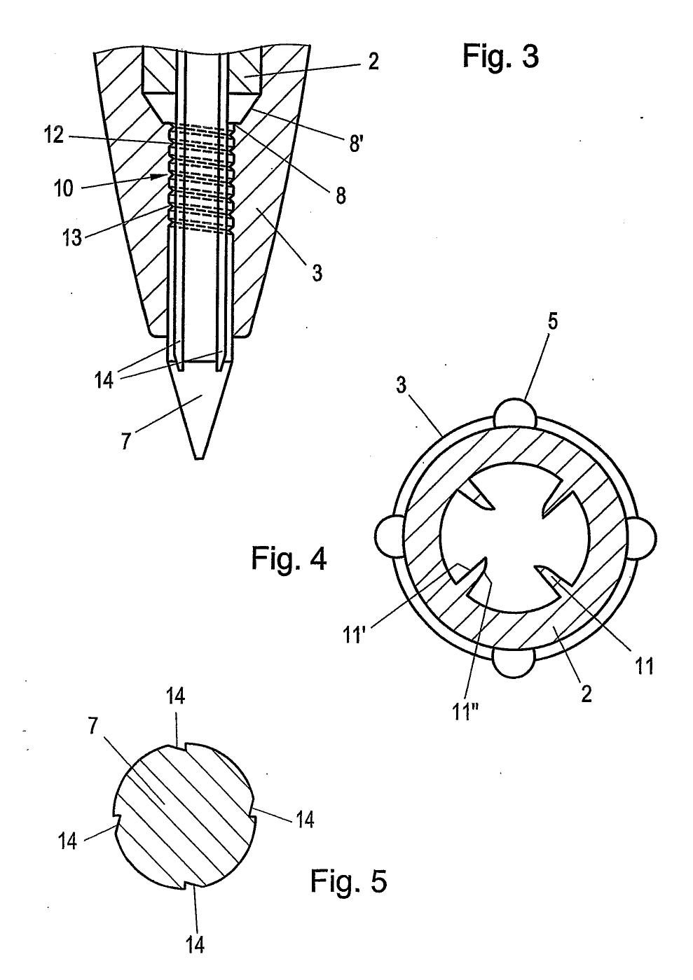

FIG. 3 shows a sectional view of the spindle-drive mechanism comprising the rotary element of the writing implement according to FIGS. 1 and 2, yet in a larger scale;

FIG. 4 shows a cross-section through the sleeve of said writing implement along line IV-IV in FIG. 1;

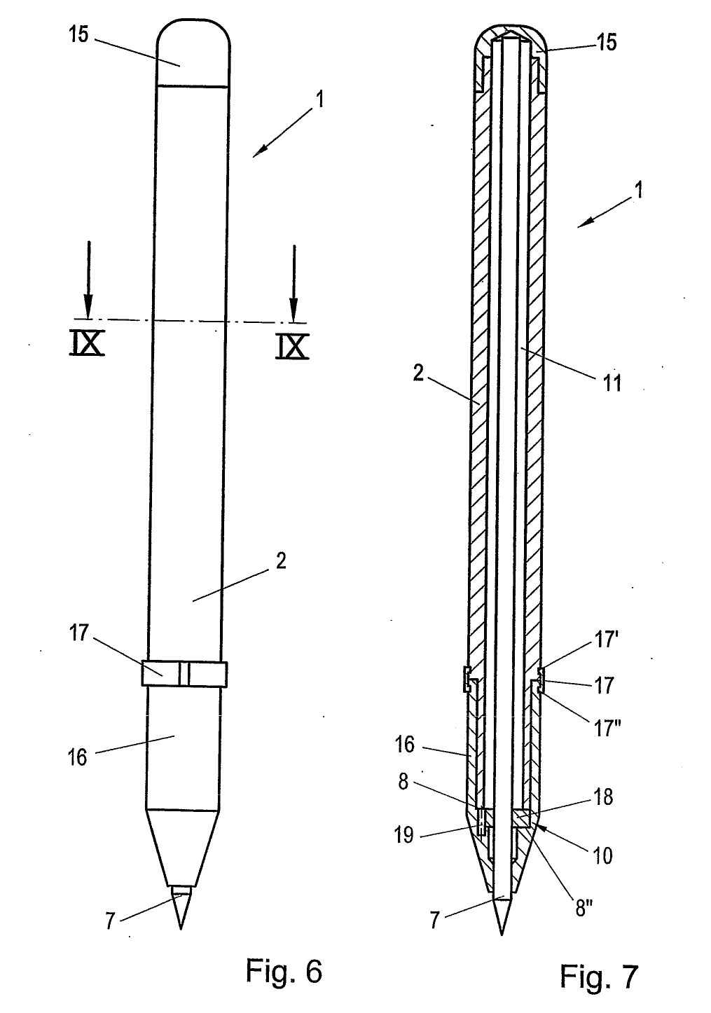

FIG. 5 shows a cross-section through a lead;

FIG. 6 shows a perspective view of an alternative writing implement;

FIG. 7 shows an axial section through the writing implement according to claim 6;

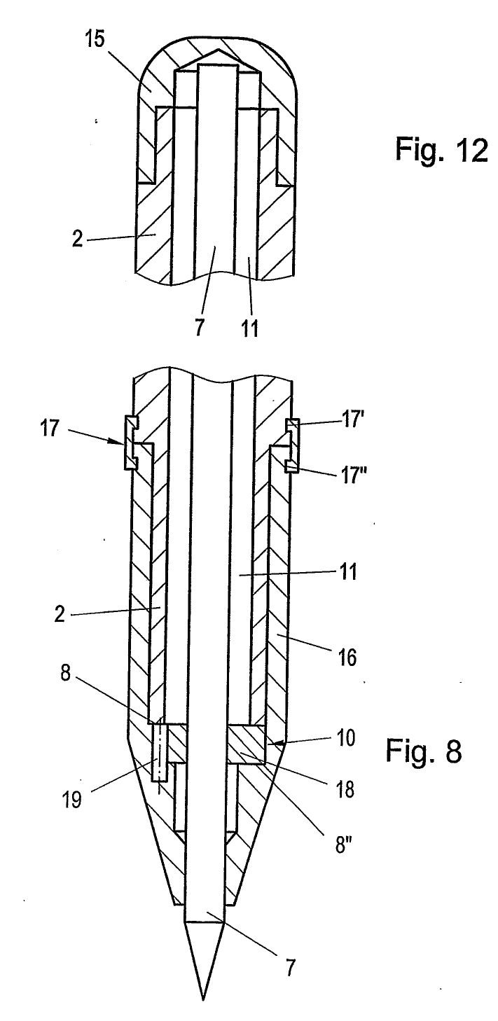

FIG. 8 shows a sectional view of the rotary element with spindle-drive mechanism of the writing implement according to FIG. 7;

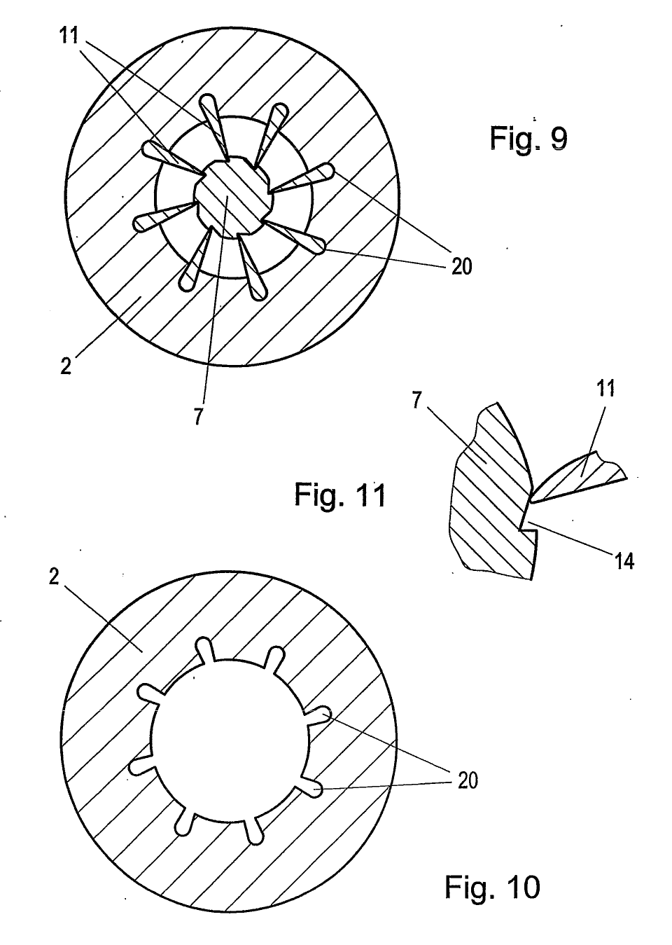

FIG. 9 shows a cross-section through the writing implement along line IX-IX in FIG. 7;

FIG. 10 shows a corresponding cross-section through an empty sleeve;

FIG. 11 shows a detailed view of a lamella engaging a longitudinal recess of the lead; and

FIG. 12 shows a sectional view of the rear end of the sleeve of the writing implement according to claim 7.

FIG. 1 shows a writing implement 1 in side view.

The writing implement 1 is made of synthetic material and has a sleeve 2 with an open front end (s. FIG. 2) and a rotary element 3, which rotary element 3 can be rotated relative to the sleeve 2. For better handling of the writing implement 1, the rotary element 3 is somewhat bulky compared to the sleeve 2 and may have longitudinal or transverse webs 4 and/or longitudinal or transverse slots, or the like, on the outer surface to provide for better grip. For the same purpose, longitudinal webs 5 may also be provided on the outer surface of the sleeve 2, e.g. in the vicinity of the rotary element 3.

Two opposing inspection windows 6 are provided at the rear end of the sleeve 2 which allow for a view into the interior of the sleeve 2 and to a lead 7 received in the sleeve 2, e.g. for identifying the color of the lead 7 from the outside.

In use, the tip of the lead 7 received in the sleeve 2 projects from the rotary element 3.

FIG. 2 shows an axial section through the writing implement 1. Here, it can be seen that the rotary element 3 is attached to the open front part 8 of the sleeve 2 by means of positive-fit connection 9. For the positive-fit connection 9, the rotary element 3 is provided with an annular boss 9′ received in an annular recess 9″ in the sleeve 2.

The lead 7 is held in the sleeve 2 by means of a spindle-drive mechanism 10 so as to be longitudinally displaceable, said spindle-drive mechanism 10 being formed by the rotary element 3 in cooperation with the lead 7. The spindle-drive mechanism 10 can be seen in more detail in FIG. 3.

At the inner side of the sleeve 2, elastic lamellae 11 are integrally formed (s. also FIG. 4) which extend across the entire length of the sleeve 2 and hold the lead 7 resiliently against unintentional rotation, and which cushion unintentional impacts.

As mentioned, the lead 7 itself is designed as a spindle, wherein it here has, e.g., a preformed external thread 12 provided along the entire length of the lead 7.

As exemplified in FIG. 3, the lead 7 is directly threadedly engaged with the rotary element 3, wherein an internal thread 13 is provided in the rotary element 3 for this purpose, which rotary element 3 itself thus forms the spindle nut. The female thread 13 of the rotary element 3 adjoins the open end 8 of the sleeve 2 which has a narrowed end section with a front chamfer 8′ so as to be received in the rotary element 3 for connection. The threads 12, 13 may have, e.g., a pitch of about 0.5 mm and a rounded thread contour, wherein the angle defined by the thread flanks may be about 60°.

When using the writing implement 1, the rotary element 3 is turned relative to the sleeve 2 so as to advance the lead 7. Thus, the lead 7, which is threadedly engaged with the rotary element 3, will be moved in the direction of the open front end of the rotary element 3, e.g. To move the lead 7 back into the sleeve 2 and/or the rotary element 3, the rotary element 3 is turned in the opposite direction, and the lead will be retracted into the sleeve 2 thanks to the threaded engagement with the rotary element 3.

Instead of providing for an already preformed external thread 12 of the lead 7 for the spindle-drive mechanism 10, the external thread 12 can also be formed on the lead 7 when it is being advanced by means of the rotary element 3 as a thread-cutting device, wherein the rotary element 3 is then preferably produced from metal.

FIG. 4 shows a cross-section through the sleeve 2 of the writing implement 1 according to FIG. 1, with no lead being inserted. In cross-section, the sleeve 2 is designed to be generally round, e.g. The representation illustrated (in the direction of the front end of the writing implement 1) also shows the longitudinal webs 5 provided at the outer surface of the sleeve 2, and the rotary element 3, which is thicker in its circumference.

In the sleeve 2, four elastic lamellae 11 are provided which are symmetrically arranged at the same angular distances of 90°, e.g. In this embodiment, they are integral with the sleeve 2, but they could also be retained in longitudinal grooves of the sleeve 2 (s. FIG. 9 and, in particular, FIG. 10). The lamellae 11 project into the interior of the sleeve 2 roughly radially so as to be capable of engaging the recesses 14 (s. FIGS. 5 and 11) of the lead 7. The lamellae 11 are of roughly triangular cross-section, wherein, seen in cross-section, a side 11′ extends substantially linearly, and the other side 11″ is designed to be curved towards the tip. The elasticity of the lamellae 11 results from their material and/or their wall thickness which is sufficiently small so as to provide for lamellae 11 to be flexible.

FIG. 5 shows a cross-section of the lead 7 in schematic representation which is insertable into a sleeve 2, as illustrated in FIG. 4. The lead 7 is of substantially round cross-section, wherein four recesses 14 are provided in the lead 7 correspondingly to the number of lamellae 11 shown in FIG. 4, which recesses 14 are present in the form of longitudinal slots and arranged at the same angular distances correspondingly to the distances of the individual lamellae 11 according to FIG. 4. The recesses or longitudinal slots 14 are of saw-tooth-shaped cross-section, which is why the lamellae 11 simply intermesh when the lead 7 is starting to rotate, thus being capable of securing the lead 7 against unintentional rotation (s. in particular also FIG. 11 in connection with a different embodiment of the writing implement 1).

FIG. 6 shows a view of a writing implement 1 modified when compared to FIGS. 1 to 5. In contrast to the above writing implement 1, the writing implement 1 of FIG. 6 is of substantially uniform, round cross-section, and an end cap 15 is attached to the rear end of the sleeve 2 (s. FIG. 7 and, in particular, FIG. 12). Furthermore, the front end of the sleeve 2 is connected to an outer rotary element 16, which rotary element 16, as can be seen in detail in FIGS. 7 and 8, is equipped with the spindle-drive mechanism 10, the latter being realized differently than in the writing implement 1 according to FIGS. 1 to 5 (s. FIG. 7 and, in particular, FIG. 8). The outer rotary element 16 is rotatably mounted at the front end of the sleeve 2, with an annular bracket 17 being arranged therefor in the transition region of the outer rotary element 16 to the sleeve 2 (s. also FIGS. 7 and 8).

FIG. 7 shows an axial section of the writing implement 1 according to FIG. 6, wherein the spindle-drive mechanism 10 is formed by the outer rotary element 16, the latter being coupled to an inner spindle nut 18 in a co-rotating manner. The rotary element 16 with the alternative spindle-drive mechanism 10 is shown in detail in FIG. 8.

At its front end, the sleeve 2 is designed to be gradually narrowed so that the outer rotary element 16 can be attached to the sleeve 2 via the open end 8 thereof, and fits snugly on the sleeve 2 (s. also FIG. 8). The rotatable connection of the sleeve 2 and the outer rotary element 16 is realized by means of the annular bracket 17 which is circumferentially attached in the transition region of the two parts which are rotatable against each other, with appropriate receiving recesses 17′ and 17″ being formed therefor at the exterior of the sleeve 2 and the outer rotary element 16. A rotatable connection of the outer rotary element 16 and the sleeve 2 may of course also be comprised of a positive-fit connection 9 with an annular boss 9′ and an annular groove 9″, as shown with the writing implement 1 according to FIG. 2.

According to FIGS. 7 and 12, the rear end of the sleeve 2 is designed to be open and is detachably connected to the end cap 15 (s. FIG. 11). At the open rear end of the sleeve 2, a cap with a rubber eraser (not illustrated) can also be removably attached, wherein an appropriate receiving recess may be provided therefore inside of the end of the sleeve.

As is the case with the writing implement 1 according to FIG. 2, elastic lamellae 11 are also provided inside of the sleeve 2 in case of the writing implement 1 according to FIGS. 6 and 7, respectively, said lamellae 11 being retained in the sleeve 2 and extending across the length of the sleeve 2. The lamellae 11 project radially into the interior of the sleeve 2 so as to engage the recesses 14 in the lead 7, to hold the lead 7 against rotation and to hold the same resiliently (s. FIGS. 9 and 11).

According to FIG. 8, the spindle-drive mechanism 10 adjoins the front of the open end 8 of the sleeve 2. The lead 7 inserted into the writing implement 1 is guided through the inner spindle nut 18, and its external thread 12 is in engagement with the internal thread (not shown) of the spindle nut 18. The inner spindle nut 18 is connected to the outer rotary element 16 in a co-rotating manner, with a pin 19 being provided therefor which is eccentrically arranged in the outer rotary element 16 and/or the spindle nut 18. Here, the lower end of the pin 19 is retained in the rotary element 16, and the top end thereof engages the spindle nut 18.

Thanks to the design of the lead 7 as a spindle which cooperates with the spindle nut 18 the lead 7, when turning the outer rotary element 16 relative to the sleeve 2, is forced to turn itself out of the writing implement 1 (or into the same) along the spindle nut 18, as is the case with the writing implement 1 of FIG. 1. Here, the spindle nut 18 is retained in place in the rotary element 16 between the front end 8 of the sleeve 2 with a nose 8″.

According to FIG. 9, eight elastic lamellae 11 are provided in the sleeve 2 which extend across the length of the sleeve 2. As is also shown in FIG. 10, the lamellae 11 are retained in eight longitudinal grooves 20 in the inner wall of the sleeve 2. The longitudinal grooves 20 are arranged symmetrically at the same angular distances to each other, yet being somewhat offset from the orientation towards the central axis of the sleeve 2. The arrangement of the lamellae 11 somewhat offset towards the central axis can ensure that the lamellae 11 anchor in the recesses 14, or longitudinal slots, of the lead 7 when the lead 7 is being screwed out. This avoids spinning of the lead 7. In their cross-section, the longitudinal grooves 20 are undercut so as to retain the lamellae 11 and secure the same against radial falling out. The lead 7 is inserted centrally into the sleeve 2, wherein the eight elastic lamellae 11 engage the recesses 14 or longitudinal slots of the lead 7, and hold the lead 7 against rotation.

FIG. 11 is a detailed representation of the cooperation of the lamellae 11 with the longitudinal slots 14 so as to hold the lead 7 against rotation. The longitudinal slots 14 at the lead 7 are of saw-tooth-shaped cross-section, as is also the case with the writing implement 1 according to FIG. 1, with the lamellae 11 of substantially triangular cross-section engaging the longitudinal slots 14. When the lead 7 is starting to rotate, the shape of the longitudinal slots 14 in combination with the shape and elasticity of the lamellae 11 allows for the lamellae 11 to snap into the longitudinal slots 14 and to then remain in engagement therewith.

Basically, the lamellae 11 may also be discontinuous in axial direction, i.e. individual lamellae (portions) may be arranged to be spaced relative to each other. The may also end in front of the rear end of the sleeve 2, e.g. when a rubber eraser insert is provided; preferably, the lamellae 11 extend as far as to the rear end of the sleeve 2.

In principle, also in case of an attached rotary element 3, 16, the lead 7 may be inserted into the writing implement 1—from the front or the rear—simply by screwing in.

To provide for a better grip, longitudinal or transverse ribs 4 or longitudinal or transverse slots or the like may be provided at the outer surface of the rotary element 16 also in case of the writing implement 1 according to FIGS. 6 to 12 (s. FIG. 1), as is the case with the writing implement 1 according to FIGS. 1 to 5. Likewise, longitudinal webs 5 may be arranged at the outer surface of the sleeve 2.

Besides a round cross-section, the writing implement 1 may for example also have substantially triangular cross-section with, e.g., strongly rounded corners so that the writing implement 1 provides for a good handling.

The inventive writing implement 1 is not only suited for leads 7 of pencils or colored pencils but also for leads of ball pens, rollerball pens, felt pens, gel pens or the like.

1. A writing implement with a sleeve, which has an open front end and in which a lead is displaceably retained by means of a spindle-drive mechanism having a rotary element, wherein the lead, which cooperates with the rotary element, itself forms the spindle and is held in the sleeve against rotation, characterized in that elastic lamellae are provided inside of the sleeve which engage recesses located on the outside of the lead.

2. The writing implement according to claim 1, characterized in that the lamellae extend across the length of the sleeve.

3. The writing implement according to claim 1, characterized in that at least three lamellae are provided at the same angular distances.

4. The writing implement according to claim 3, characterized in that at least four lamellae are provided.

5. The writing implement according to claim 1, characterized in that the lamellae are integral with the sleeve.

6. The writing implement according to claim 1, characterized in that the lamellae are retained in the sleeve in longitudinal grooves at the inner side of the sleeve.

7. The writing implement according to claim 1, characterized in that the recesses in the lead are formed by longitudinal slots which are saw-tooth-shaped in cross-section.

8. The writing implement according to claim 1, characterized in that the rotary member is arranged at the front end of the sleeve.

9. The writing implement according to claim 1, characterized in that the rotary element itself forms the spindle nut.

10. The writing implement according to claim 1, characterized in that an outer rotary element is provided which is connected to an inner spindle nut in a co-rotating manner.

11. The writing implement according to claim 10, characterized in that the co-rotating connection is formed by an eccentric pin which is retained in the rotary element and engages the spindle nut (18).

12. The writing implement according to claim 1, characterized in that the lead has a preformed thread.

13. The writing implement according to claim 1, characterized in that the internal thread of the rotary element and/or the spindle nut is designed as a thread-cutting device for the lead.

14. The writing implement according claim 1, characterized in that the rotary element is detachably connected to the sleeve by means of a snap-fit connection.

15. The writing implement according to claim 1, characterized in that the rotary element is retained rotatably at the sleeve by means of an annular bracket.

16. The writing implement according to claim 1, characterized in that at least one inspection window is provided at the sleeve.

17. The writing implement according to claim 1, characterized in that an end cap is detachably connected to the rear end of the sleeve.

18. The writing implement according to claim 1 characterized in that the sleeve is made of polyamide 6.6.

19. The writing implement according to claim 1, characterized in that the rotary part is made of polyamide 6.6.
